(19) United States
(12) Patent Application Publication
(10) Pub. No.: US 2016/0082296 A1
(43) Pub. Date: Mar. 24, 2016

(54) FULLY SEALED ANTI-POLLUTION MASK

(71) Applicant: HENRY B. SUNG, San Jose, CA (US)

(72) Inventor: HENRY B. SUNG, San Jose, CA (US)

(21) Appl. No.: 14/855,671

(22) Filed: Sep. 16, 2015

(30) Foreign Application Priority Data
Sep. 18, 2014 (CN) 201420538535.X

(51) Int. Cl. A62B 18/08; A62B 23/02; A62B 9/04; A62B 18/02

(52) U.S. Cl. CPC A62B 18/084; A62B 18/02; A62B 23/025; A62B 9/04

(57) ABSTRACT

The utility model provides a mask, a mask body (10) and a filter assembly (20) coupled to the mask body (10), the mask body (10) comprising a face seal (11) installed on the filter assembly (20), the face seal (11) sealed to a wearer's face around the mouse and nose; and a semi-rigid rim (12), fitting in between the filter assembly (20) and the face seal (11), the semi-rigid rim (12) supporting the face seal (11) to ensure it sealed to the wearer's face. The embodiments of the present utility model effectively solve the problem in existing designs that mask cannot effectively seal to the wearer's face.

### CROSS-REFERENCE TO RELATED APPLICATION

This application claims the priority of Chinese Patent Application No. 201420538535.X, filed on Sep. 18, 2014, which is incorporated herein by reference.

### FIELD OF THE INVENTION

The present disclosure relates generally to masking devices, and more particularly to a new mask design.

### BACKGROUND OF THE INVENTION

Masking devices provide certain filtering on the air inhaled into human lungs. During an epidemic of infectious respiratory disease, or when operating in a polluted environments (e.g. dust), wearing a mask provides good protection.

Standards to determine the effectiveness of a dust mask are based on its performance to filter or block respirable dust with a diameter of 5 microns or less. These particles can directly enter alveoli, causing health hazard. General gauze masks block dust with its mechanical barriers. Dust particles are filtered through layers of barriers in the gauze mesh, which only blocks the larger ones; whereas the fine ones, especially those with a diameter of 5 microns or less, will pass through and get into the respiratory system.

PM2.5 refers to atmospheric particulate matter with a diameter of 2.5 microns or less, also known as particulates that can penetrate deep into human lungs. While only contributing to a small percentage of the Earth's atmosphere, PM2.5 has a significant impact on the air quality and visibility. PM2.5 particles are small-sized, but rich in toxic and hazardous substances, and characterized with long residual time and transmission distance, thus greatly affect air quality and human health.

One of the counter measures adapted by people against fog and haze is to avoid outdoor activities as much as possible. When going out is inevitable, one should always wear a mask for protection. Choosing a proper anti-fog and haze mask depends on whether the mask can truly filter PM2.5 particles and whether the mask can tightly seal to the wearer's face.

Existing masks can hardly provide effective protection against fog and haze, mainly because those masks cannot lock to the wearer's face with sufficient seal. Thus unfiltered air may enter the mask directly from the gap between the face and the mask, and then get inhaled into wearer's lungs.

### BRIEF DESCRIPTION OF THE INVENTION

Embodiments of the present utility model provide a mask, which solves the problem in existing mask designs where masks cannot securely lock into wearers' faces.

In order to solve the abovementioned problem, embodiments of the present utility model provide a mask comprising a mask body and a filter assembly coupled to the mask body. The mask body includes a face seal, installed on the filter assembly and conformed to the contour of wearer's face around mouse and nose; and a semi-rigid rim, fitting in between the filter assembly and the face seal, supports the face seal to ensure a sufficient seal to the wearer's face.

In one embodiment, the face seal comprises a first arc segment and a second arc segment, wherein the first arc segment is concave with respect to the circumference of the semi-rigid rim and adapted to the wearer's nasion, and wherein the second arc segment is concave with respect to the circumference of the semi-rigid rim and adapted to the wearer's chin.

In one embodiment, the face seal further comprises two groups of segments, wherein each group includes a third arc segment and an adjacent fourth arc segment and interconnects the first arc segment and the second arc segment. The third arc segment is convex with respect to the circumference of the semi-rigid rim and adapted to the zygomaticomaxillary sutures of the wearer's face, while the fourth arc segment is convex with respect to the circumference of the semi-rigid rim and adapted to the wearer's lip corners.

In one embodiment, the face seal is symmetrically constructed.

In one embodiment, the shape around the circumference of the semi-rigid rim matches that of the face seal.

In one embodiment, the thickness of the semi-rigid rim is approximately one and a half to three times of the thickness of face seal.

In one embodiment, the filter assembly comprises a shell with built-in filters, which are positioned corresponding to the nostrils of the wearer.

In one embodiment, the filters include twin filters on the shell positioned corresponding to the left and right nostrils, respectively.

In one embodiment, the mask further comprises a pair of strap mounts, symmetrically mounted on both sides of the shell.

In one embodiment, the shell is made from transparent material.

In an application of the present utility model, the mask comprises the mask body and the filter assembly coupled to the mask body, wherein the mask body is attached to the face of the wearer, and the filter assembly filters the air inhaled into the body of the wearer. The mask body includes the face seal and the semi-rigid rim, wherein the face seal is installed on the filter assembly and sealed to the face of the wearer. Apparently, the face seal should provide an adequate seal around the mouth and nose of wearer, so that the air inhaled by the wearer is filtered by the air filter assembly.

In the present utility model, the semi-rigid rim joins the face seal with the filter assembly and provides elastic support to the face seal. People differ in their facial bone shapes. Different nose bridge heights and chin levels in people may introduce gaps between the mask and wearers faces. While the semi-rigid rim provides elastic support to the face seal to ensure that the face seal conforms closely and tightly with the contour of a wearer's face.

### BRIEF DESCRIPTION OF THE DRAWING

As part of this application, drawings are used to provide further understanding of the present utility model. The exemplary embodiments are used to describe the utility model, and should not constitute limitations of present the utility model. In the drawings:

FIG. 1 illustrates a schematic view of the overall structure of the mask, according to one embodiment.

FIG. 2 illustrates a schematic view of the structure of the mask body, according to the embodiment in FIG. 1.

FIG. 3 illustrates a schematic front view of the mask body, according to the embodiment in FIG. 2.

FIG. 4 illustrates a schematic side view of the mask body, according to the embodiment in FIG. 2.

The above figures include the following reference numbers:

10: mask body; 11: face seal including: 111: first arc segment; 112: second arc segment; 113: third arc segment; 114: fourth arc segment; 12: semi-rigid rim; 20: filter assembly; 21: shell; 22: filters; 23: strap mount.

### DETAILED DESCRIPTION OF PREFERRED EMBODIMENTS

Note that in the present disclosure, embodiments and various features of the embodiments may be combined when they are not conflicting with each other. Embodiments of the present disclosure will herein be described in detail by way of examples with reference to the accompanying drawings.

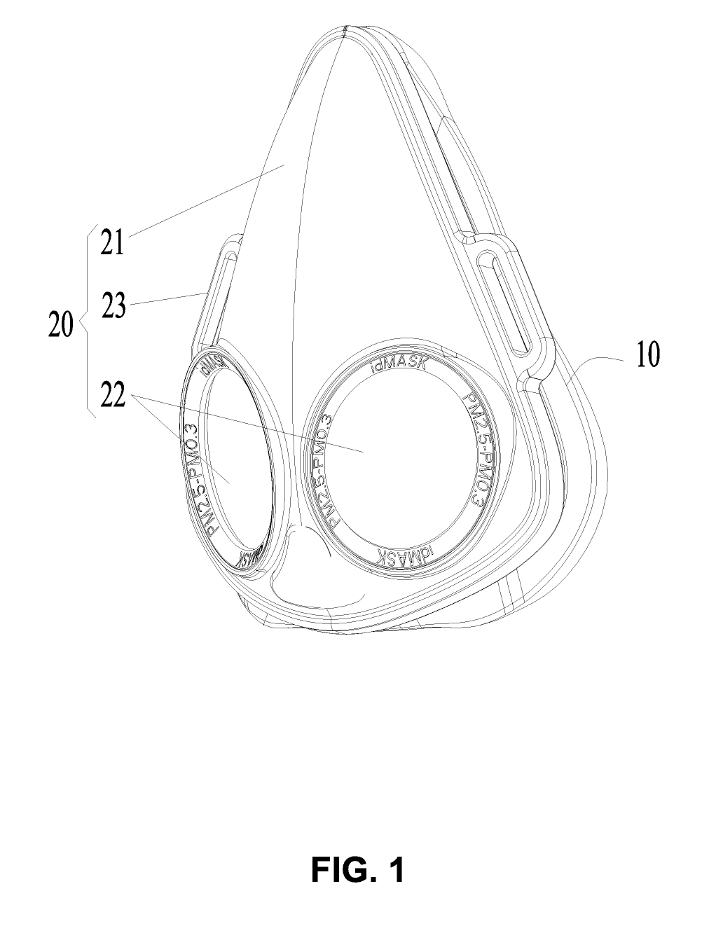

Referring to FIG. 1, there is shown an illustrative embodiment of a mask comprising a mask body 10 and a filter assembly 20 coupled to the mask body 10. The mask body 10 includes a face seal 11 and a semi-rigid rim 12. The face seal 11 is installed on the filter assembly 20, and can be attached to a wearer's face to envelop the area around the wearer's mouth and nose. The semi-rigid rim 12 joins the face seal 11 with the filter assembly 20, and supports the face seal 11 to be flexibly sealed to the face of the wearer.

In an application of the present utility model, the mask comprises the mask body 10 and the filter assembly 20 coupled to the mask body 10, wherein the mask body 10 is attached to the face of the wearer, and the filter assembly 20 filters the air inhaled into the body of the wearer. The mask body 10 includes a face seal 11 and the semi-rigid rim 12, wherein the face seal 11 is installed on the filter assembly 20 and sealed to the face of the wearer. Apparently, the face seal 11 should provide an adequate seal around the mouth and nose of wearer, so that the air inhaled by the wearer is filtered by the air filter assembly 20.

In the present utility model, the semi-rigid rim 12 joins the face seal 11 with the filter assembly 20 and provides elastic support to the face seal 11. People differ in their shapes of facial bones. Different nose bridge heights and chin levels in people may introduce gaps between the mask and wearers faces. While the semi-rigid rim 12 provides elastic support to the face seal 11 to ensure that the face seal 11 conforms closely and tightly with the contour of a wearer's face.

Preferably, the shape around the circumference of the semi-rigid rim 12 matches that of the face seal 11, so that the face seal 11 can be flexibly adapted to different faces. In order to adapt to different facial bones among populations, the thickness of the semi-rigid rim 12 is designed to be approximately one and a half to three times of that of the face seal 11. Semi-rigid rims within that range of thickness can not only be deformed and compressed to accommodate convex portions of the wearer's face, but also can elastically support the face seal 11 to adapt to concave portions of the face. The optimal thickness of the semi-rigid rim 12 is about two times of thickness of the face seal 11.

It should be noted that the semi-rigid rim 12 and the face seal 11 are both made of silica gel, which is soft and elastic and of comfortable fit. In addition, studies show that silica gel allergy is almost non-existent.

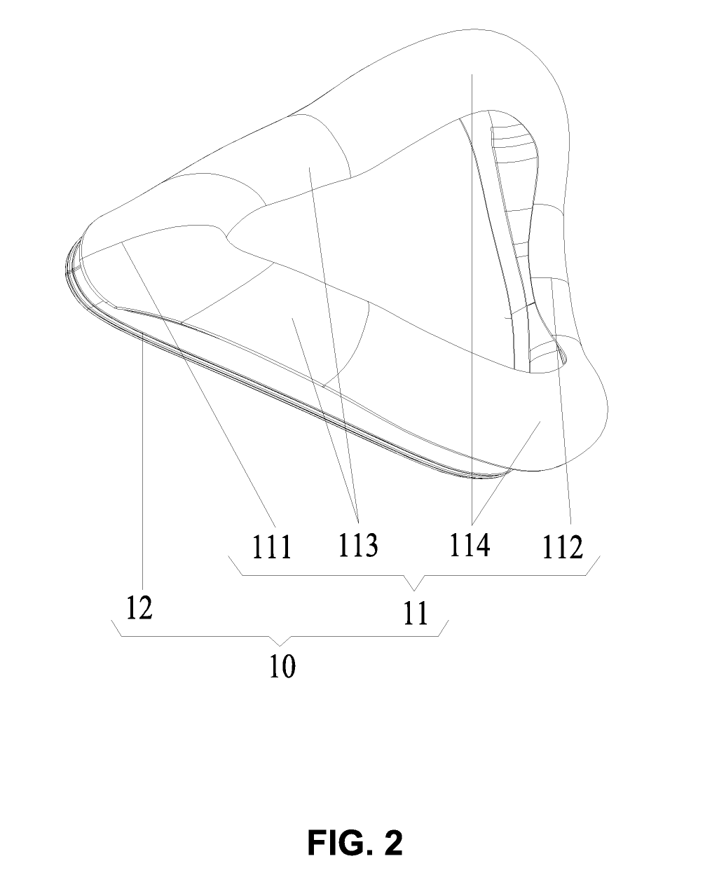

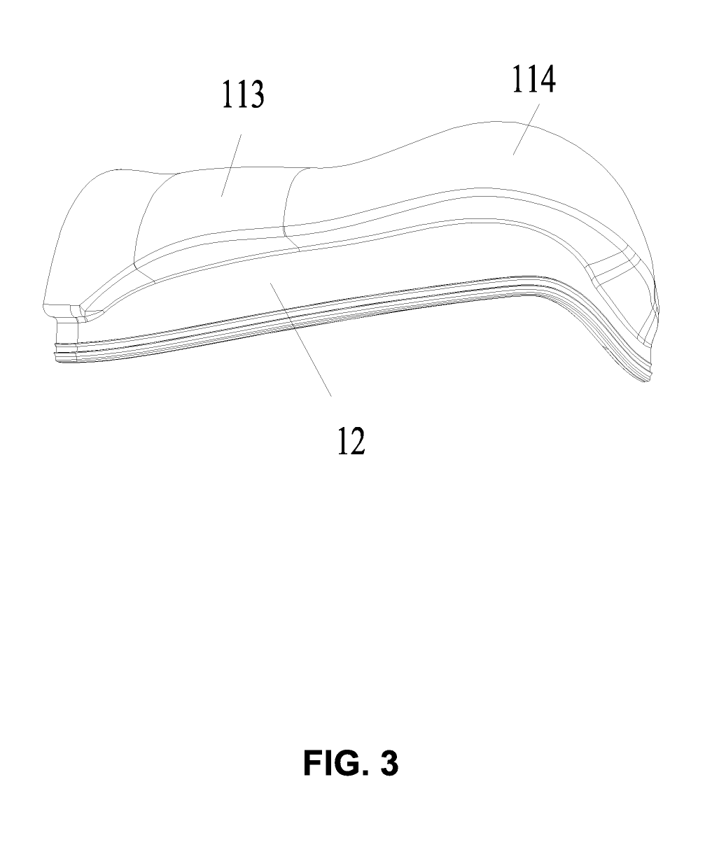

Referring now to FIG. 2 and FIG. 3. In the present embodiment, the face seal 11 comprises a first arc segment 111 and a second arc segment 112, wherein both segments are concave with respect to the circumference of the semi-rigid rim 12. The first arc segment 111 is adapted to the wearer's nasion, while the second arc segment 112 is adapted to the wearer's chin. Research has shown there is little difference in the width of people's nose root or nasion, which is selected to be the fitting position of the first arc segment 11. The different heights of nose bridges among people are then adapted to by the elasticity and support from the semi-rigid rim 12, so that gap and leakage can be avoided. Similarly, different levels of chins among populations are first adapted to by the concave shape of the second arc section 112 with respect to the circumference of the semi-rigid rim 12. When wearers with high chins wear the mask, the semi-rigid rim 12 would be partially compressed to accommodate the protruding chins, ensuring a sufficient seal between the face seal 11 and wearers' faces.

It should be noted that the outer width of the mask body 10 corresponding to the wearer's mouth is 10 cm, and the inner width is 6 cm. Since the average width between two corners of the lips is typically less than 6 cm, it will not affect activities of the wearer's mouth when wearing the mask.

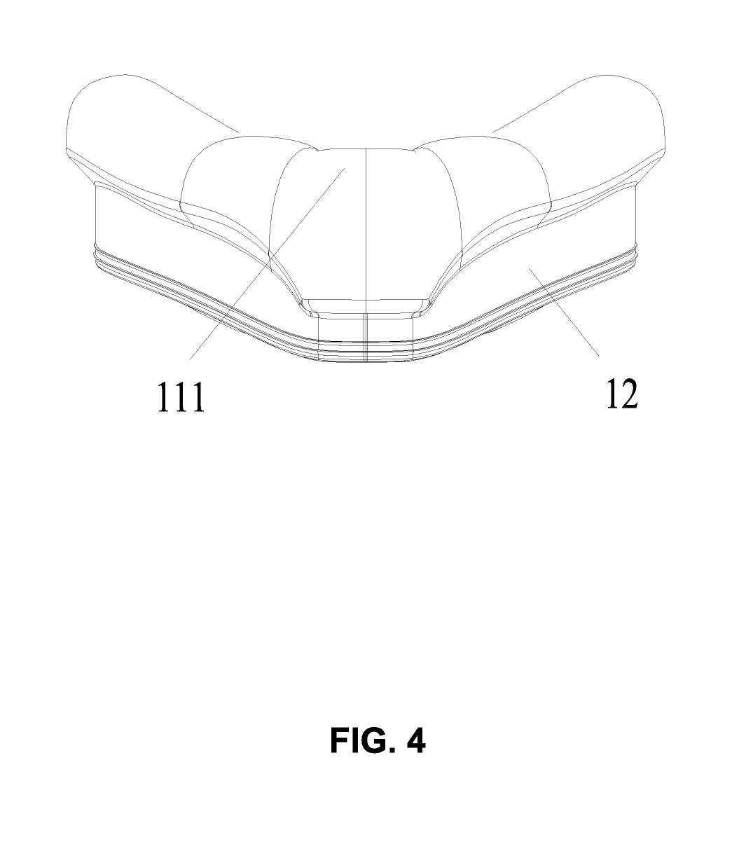

Referring now to FIG. 3 and FIG. 4. In the present embodiment, the face seal 11 further comprises two groups of segments: each includes a third arc segment 113 and an adjacent fourth arc segment 114, and interconnects the first arc segment 111 and the second arc segment 112. Both segments 113 and 114 are convex with respect to the circumference of the semi-rigid rim 12. The third arc segment 113 is adapted to the zygomaticomaxillary sutures of the wearer's face, while the fourth arc segment 114 adapts to the wearer's lip corners. The zygomaticomaxillary sutures and lip corners are relative recess areas on human face due to the absence of bone support. Therefore the third arc segment 113 and the fourth arc segment 114 are designed in the abovementioned way to better conform to the contours of the human face, providing adequate seals between the face seal 11 and wearer's face. Furthermore, the face seal 11 may be constructed in a single layer or in two or more layers. For example, a three-layer face seal can be ergonomically designed to comfortably create an airtight seal around the wearer's face. The outermost layer is ultra-soft and the thinnest among all the layers, directly attached to the wearer's face to ensure full contact around the wearer's nose and mouse. While the inside silica layers provide structural support (like a cartilage in ears) for the outer layer and hold the wearer's face tightly inside the mask. When worn by the wearer, each layer of the face seal 11 touches and suppresses the next layer below to disperse pressure and facilitate a soft, but structurally sound seal.

In the present embodiment, the mask is manufactured in a symmetrical fashion along the philtrum of human face.

Referring back to FIG. 1. In the present embodiment, the filter assembly 20 comprises a shell 21 with built-in filters 22, which are positioned corresponding to the nostrils of the wearer. The filters' nostril positions can assist the wearer's breathing. Preferably, the filters 22 placed on the shell 21 include twin filters, which correspond to the left and right nostrils, respectively. This can effectively increase the filtration area of the mask and allow the wearer to breathe more smoothly.

As shown in FIG. 1, in the present embodiment, the mask further comprises a strap mount 23, two of which can be symmetrically mounted on both sides of the shell 21. In the present embodiment, the strap mount 23 is mounted on the shell 21 to ensure the effective use of the mask body 10. If the strap mount 23 is mounted on the mask body 10, the strap may stretch from both sides of the mask body 10, causing the deformation of the mask body 10, which may result in insufficient seal or even gaps between the mask body and the wearer's face.

In the present embodiment, the shell 21 is made from transparent material, preferably polyvinyl chloride (PC) suitable for food packaging, which is harmless to human body, safe, reliable, and rugged. A transparent and aesthetic design of shell 21 allows clear identification of the wearer through the mask, facilitating easy communication. Furthermore, the twin filters practically increase the filtration area to ensure smooth breathing.

The above describes exemplary embodiments of the present utility model, and not a limitation of the use of the present utility model or similar products. Any person having ordinary skill in the art can take on various modifications, alterations and improvements without departing from the spirit and scope of the disclosure. Accordingly, it is to be understood that the embodiments of the present disclosure to be controlled by the limitations set forth in the claims and any equivalents thereof.

1. A mask comprising:
a mask body (10) and a filter assembly (20) coupled to the mask body (10), the mask body (10) comprising:
a face seal (11), installed on the filter assembly (20), the face seal (11) sealed to a wearer's face around the mouse and nose; and
a semi-rigid rim (12), fitting in between the filter assembly (20) and the face seal (11), the semi-rigid rim (12) supporting the face seal (11) to ensure it sealed to the wearer's face.

2. The mask of claim 1, wherein the face seal (11) comprises a first arc segment (111) and a second arc segment (112), wherein the first arc segment (111) is concave with respect to the circumference of the semi-rigid rim (12) and adapted to the wearer's nasion, and wherein the second arc segment (112) is concave with respect to the circumference of the semi-rigid rim (12) and adapted to the wearer's chin.

3. The mask of claim 2, wherein the face seal (11) further comprises two groups of segments, each group including a third arc segment (113) and an adjacent fourth arc segment (114), which interconnect the first arc segment (111) and the second arc segment (112), wherein the third arc segment (113) is convex with respect to the circumference of the semi-rigid rim (12) and adapted to the zygomaticomaxillary sutures of the wearer's face, and wherein the fourth arc segment (114) is convex with respect to the circumference of the semi-rigid rim (12) and adapted to the wearer's lip corners.

4. The mask of claim 3, wherein the face seal (11) is symmetrically constructed.

5. The mask of claim 1, wherein the shape around the circumference of the semi-rigid rim (12) matches that of the face seal (11).

6. The mask of claim 5, wherein the thickness of the semi-rigid rim (12) is approximately one and a half to three times of the thickness of face seal (11).

7. The mask of claim 1, wherein the filter assembly (20) comprises a shell (21) with built-in filters (22), the filters (22) are positioned on the shell (21) corresponding to the nostrils of the wearer.

8. The mask of claim 7, wherein the filters (22) include twin filters on the shell (21) positioned corresponding to the left and right nostrils of the wearer, respectively.

9. The mask of claim 7, further comprises a strap mount (23), the strap mount (22) including a pair of mounts symmetrically mounted on both sides of the shell (21).

10. The mask of claim 7, wherein the shell (21) is made from transparent material.

11. The mask of claim 1, wherein the face seal (11) is constructed in two or more layers including an outermost layer and at least one inside layers.

12. The mask of claim 11, wherein the outermost layers of the two or more layers is directly attached to the wearer's face to ensure full contact around the wearer's nose and mouse, and wherein the at least one inside layers provide structural support for the outer layer and hold the wearer's face tightly inside the mask.
